(19) United States
(12) Patent Application Publication
(10) Pub. No.: US 2026/0334674 A1
(43) Pub. Date: Oct. 29, 2026

(54) CABINET PANEL MOUNTING STRUCTURE

(71) Applicant: AAC ACOUSTIC TECHNOLOGIES (SHENZHEN) CO., LTD., Shenzhen (CN)

(72) Inventors: Xinghua Ning, Shenzhen (CN); Shaoqiang Chen, Shenzhen (CN); Fangwei Wei, Shenzhen (CN); Zengjie Lu, Shenzhen (CN)

(21) Appl. No.: 19/326,704

(22) Filed: Sep. 11, 2025

Related U.S. Application Data
(63) Continuation of application No. PCT/CN2025/091792, filed on Apr. 28, 2025.

(51) Int. Cl. A47B 96/20; A47B 96/14; F16B 5/02; F16B 5/12

(52) U.S. Cl. CPC A47B 96/20; A47B 96/1466; F16B 5/02; F16B 5/12

(57) ABSTRACT

A cabinet panel mounting structure is provided according to the present disclosure, which includes a cabinet frame, including a frame body, a mounting groove, and a plurality of threaded portions preset on the frame body, a panel, including a first mounting plate, two connecting plates formed by bending and extending from two opposites ends toward the frame body, and two second mounting plates respectively formed by bending and extending from the two connecting plates in opposite directions and spaced apart from each other, a plurality of avoidance holes extend through the first mounting plate, a plurality of through holes extend through the two second mounting plates, and a respective avoidance hole of the plurality of avoidance holes corresponds to a respective through hole of plurality of through holes, a plurality of sleeves, a plurality of bolts, and a plurality of blocking covers.

### CROSS REFERENCE TO RELATED APPLICATIONS

The present application is a continuation of PCT Patent Application No. PCT/CN2025/091792, filed Apr. 28, 2025, which is incorporated by reference herein in its entirety.

### TECHNICAL FIELD

The present disclosure relates to the technical field of cabinet structures, and in particular to a cabinet panel mounting structure.

### BACKGROUND

In the technical field of cabinet structures, a panel that does not need to be disassembled frequently is generally fixed by bolts, that is, threaded holes are preset on the panel and a cabinet, and the bolts are screwed into the threaded holes of the cabinet through the through holes of the panel by using tools such as wrenches, electric screwdriver and screwdrivers, so as to realize the tight connection between the panel and the cabinet. Sine the panels are appearance parts, most panels need to be painted and sprayed with plastic. However, the bolts generally scratch the coating during assembly, thereby resulting in appearance defects.

In the cabinet panel mounting structures in related art, two main bolt mounting methods for the panel are provided: one method is to connect the panel and the cabinet with hex head cap bolts or socket head cap bolts, which can effectively prevent looseness in the scenes of impact and vibration with simple mounting method. However, the exposed bolt head may cause scratching injury to people or other objects during use. If the bolts are used in a compact scene, there is a risk of collision damage, which seriously affects the appearance and aesthetic beauty. The other method is to connect the panel and the cabinet with countersunk head bolts. The connection method is difficult to ensure the long-term stability of the connection only by the pre-tightening force of the bolts themselves in the scenes of impact and vibration, and generally needs to cooperate with other anti-loosening devices, which increases the cost and design complexity. Secondly, machining countersunk holes matched with bolt heads on the panel requires high machining accuracy. If the size or shape of countersunk holes is not accurate, it will affect the bolt installation and connection effect, thereby increasing the installation difficulty and cost. Finally, since machining of countersunk holes may lead to excessive reduction in the strength of connecting members or even penetrate through the panel, the countersunk head bolts are not suitable for the panel with a relatively thin thickness.

Therefore, it is necessary to provide a novel cabinet panel mounting structure to solve the above problems.

### SUMMARY

The technical problem to be solved by the present disclosure is to provide a cabinet panel mounting structure, which is convenient in installation, good in panel hiding effect, and more beautiful and aesthetic in the cabinet.

In order to solve the above technical problem, a cabinet panel mounting structure is provided according to some embodiments of the present disclosure, which includes:
a cabinet frame, including a frame body, a mounting groove recessed inward from a side of a periphery of the frame body, and a plurality of threaded portions preset on the periphery of the frame body;
a panel, covering the frame body and having a periphery arranged in the mounting groove, where the panel includes a first mounting plate, two connecting plates formed by bending and extending from two opposites ends toward the frame body, and two second mounting plates respectively formed by bending and extending from the two connecting plates in opposite directions and spaced apart from each other, a plurality of avoidance holes extend through the first mounting plate, a plurality of through holes extend through the two second mounting plates, a respective avoidance hole of the plurality of avoidance holes corresponds to a respective through hole of plurality of through holes, and the two second mounting plates abut against the frame body to align the plurality of through holes with the plurality of threaded portions;
a plurality of sleeves, where one end of a respective sleeve of the plurality of sleeves is arranged in a respective avoidance hole of the plurality of avoidance holes, and the other end of the respective sleeve abuts against a respective second mounting plate and is arranged opposite to a respective through hole of the plurality of through holes;
a plurality of bolts, where a respective bolt of the plurality of bolts passes through a respective avoidance hole, a respective sleeve and a respective through hole in a listed sequence, and extends to be screwed and fixed to a respective threaded portion; and
a plurality of blocking covers, where a respective blocking cover of the plurality of blocking covers is arranged in a respective avoidance hole and abuts against an end of a respective bolt away from the cabinet frame.

As an improvement, the plurality of avoidance holes are arranged side by side, and the plurality of through holes are arranged side by side.

As an improvement, the respective blocking cover includes a blocking cover body and a connecting portion formed by extending the blocking cover body toward the cabinet frame, the connecting portion is inserted into a respective sleeve and abuts against the end of the respective bolt away from the cabinet frame, and the blocking cover body abuts against a side of the first mounting plate away from the cabinet frame.

As an improvement, the cabinet panel mounting structure further includes flat washers and elastic washers. A respective elastic washer of the elastic washers and a respective flat washer of the flat washers are sleeved on a screw rod of the respective bolt and clamped between a bolt head of the respective bolt and the respective second mounting plate.

As an improvement, a size of the respective avoidance hole is greater than or equal to a diameter of the respective flat washer.

As an improvement, a distance between the first mounting plate and the respective second mounting plate is greater than or equal to a sum of a thickness of the bolt head of the respective bolt, a thickness of the respective flat washer matched with the respective bolt and a thickness of respective the elastic washer matched with the respective bolt.

As an improvement, a size of the respective through hole is greater than or equal to a nominal diameter of a screw rod of the respective bolt.

As an improvement, the first mounting plate is parallel to the two second mounting plates.

As an improvement, the two connecting plates are perpendicular to the first mounting plate and the two second mounting plates.

As an improvement, a respective threaded portion of the plurality of threaded portions is any one of a threaded hole, a welded nut, a pressing rivet nut and a pulling rivet nut.

Compare with that related art, in the cabinet panel mounting structure according to the present disclosure, the plurality of threaded portions preset on the frame body are arranged on the cabinet frame. The plurality of avoidance holes extend through the first mounting plate of the panel, and the plurality of through holes extend through the second mounting plates. Each avoidance hole corresponds to a respective through hole, and the second mounting plates are attached to the frame body, so that the through holes are arranged corresponding to the threaded portions. One end of each sleeve is arranged in a respective avoidance hole, and the other end abuts against the second mounting plate and is opposite to the respective through hole. Each bolt sequentially passes through the respective avoidance hole, the respective sleeve and the respective through hole, and extends to be screwed and fixed to the respective threaded portion. Each blocking cover is arranged in the respective avoidance hole and abuts against the end of the bolt away from the cabinet frame. By using the two-layer structure formed by the first mounting plate and the second mounting plate of the panel and the cooperation of the blocking cover and the avoidance hole, the bolt head is hidden between the first mounting plate and the second mounting plate, and the indentation possibly caused by the fastening of the bolt is shielded, so that the cabinet is more beautiful and aesthetic.

### BRIEF DESCRIPTION OF THE DRAWINGS

In order to explain the technical solution of the present disclosure more clearly, a brief description will be given to the accompanying drawings required for the description of the embodiments. Obviously, the drawings in the following description are only some embodiments of the present disclosure, and other drawings can be obtained by those skilled in the art according to these drawings without creative efforts.

FIG. 1 is a schematic perspective view of a cabinet panel mounting structure provided by an embodiment of the present disclosure.

FIG. 2 is a schematic exploded view of the cabinet panel mounting structure provided by an embodiment of the present disclosure.

FIG. 3 is a cross-sectional view of the cabinet panel mounting structure taken along line A-A in FIG. 1.

FIG. 4 is an enlarged view of portion B in FIG. 3.

FIG. 5 is a schematic structural diagram of a panel of the cabinet panel mounting structure provided by an embodiment of the present disclosure.

FIG. 6 is a schematic structural diagram showing the cooperation between a panel and sleeves of the cabinet panel mounting structure provided by an embodiment of the present disclosure;

FIG. 7 is a schematic structural diagram showing the assembly of a bolt, a flat washer and an elastic washer of the cabinet panel mounting structure provided by an embodiment of the present disclosure.

### REFERENCE NUMERALS ARE LISTED AS FOLLOWS

100, cabinet panel mounting structure;
1, cabinet frame;
11, frame body;
12, mounting groove;
13, threaded portion;
2, panel;
21, first mounting plate;
211, avoidance hole;
22, second mounting plate;
221, through hole;
23, connecting plate;
3, sleeve;
4, bolt;
5, blocking cover;
51, blocking cover body;
52, connecting portion;
6, flat washer;
7, elastic washer.

### DETAILED DESCRIPTION OF THE EMBODIMENTS

In the following, the technical solution in the present disclosure will be clearly and completely described with reference to the attached drawings. Obviously, the described embodiment is only a part of the embodiments of the present disclosure, not all the embodiments. Based on the embodiments in the present disclosure, all other embodiments obtained by those skilled in the art without creative efforts fall within the protection scope of the present disclosure.

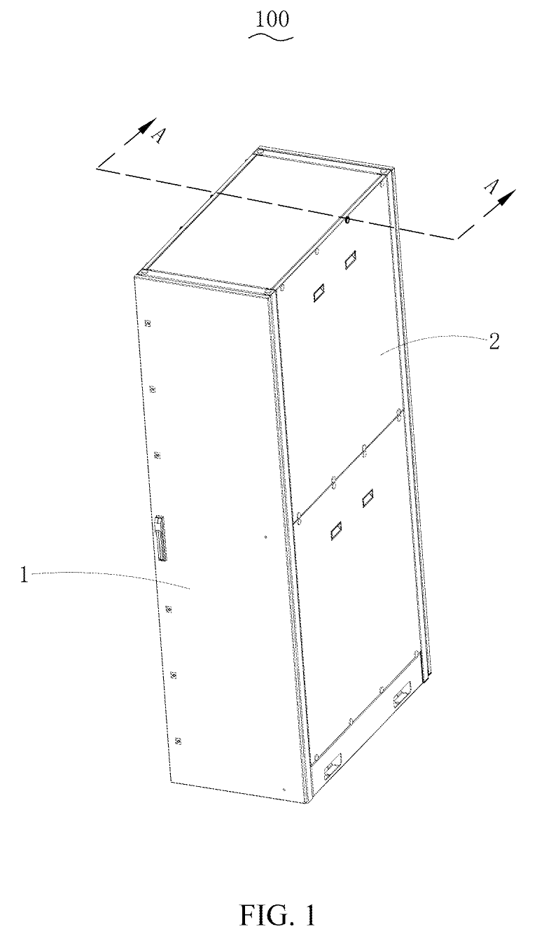

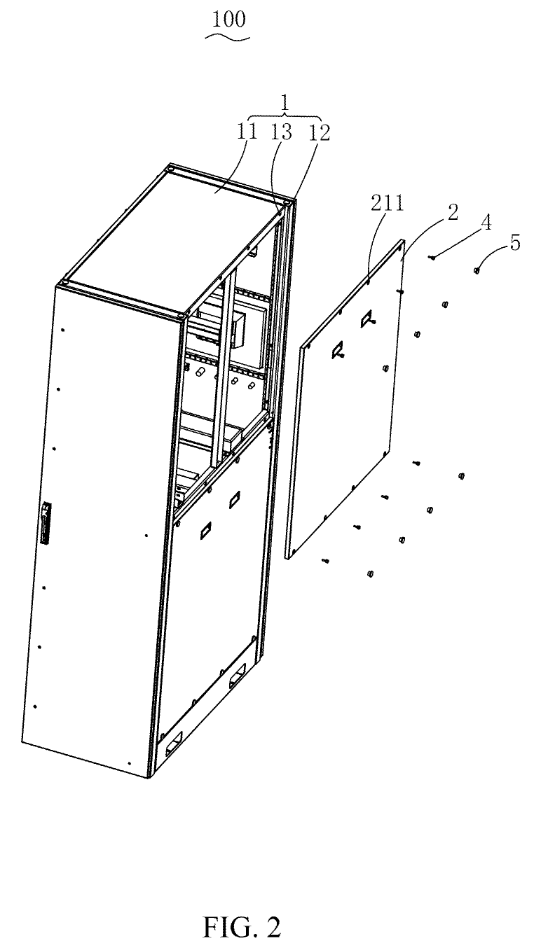

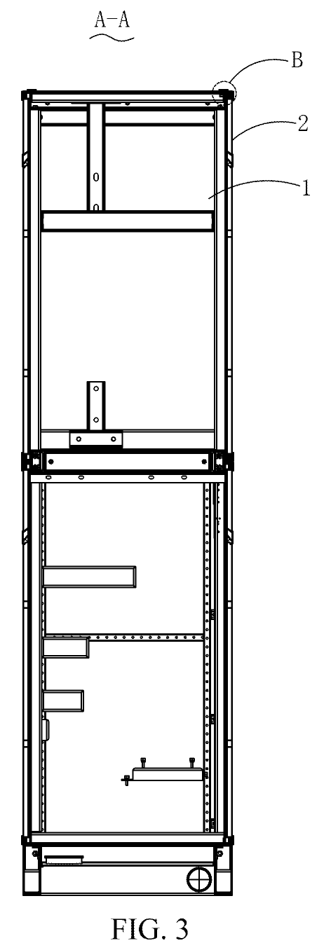

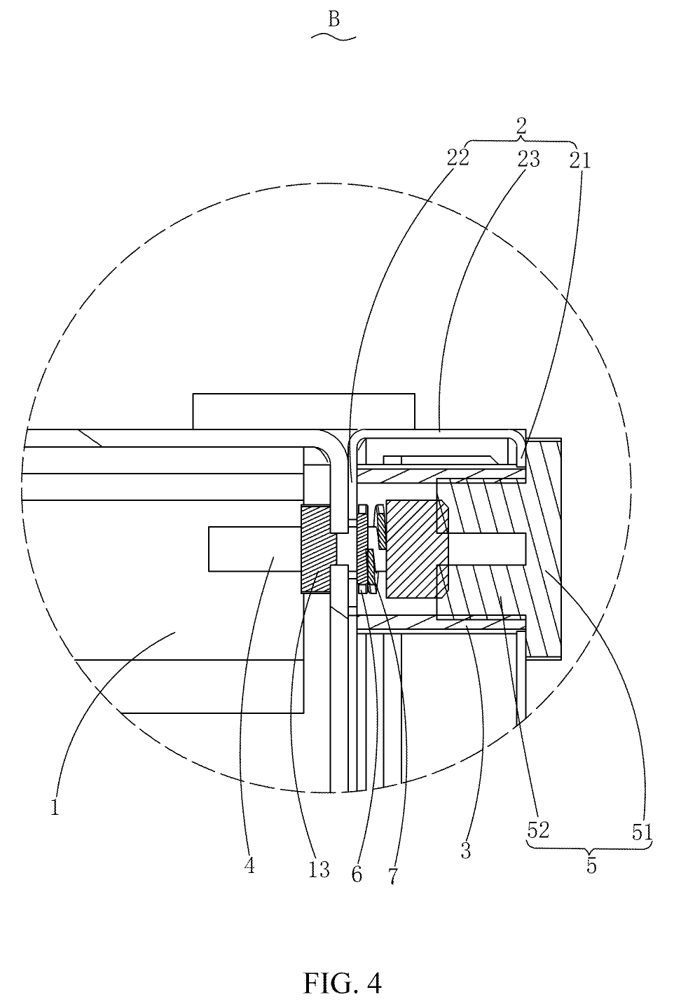

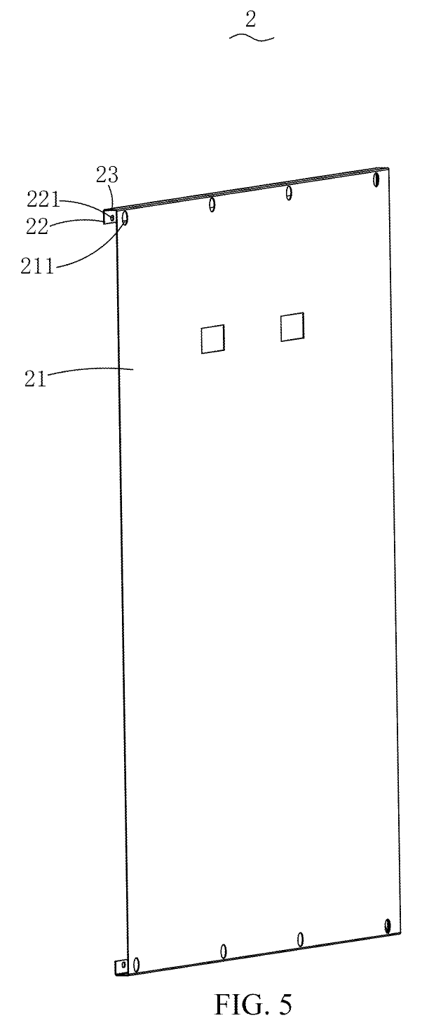

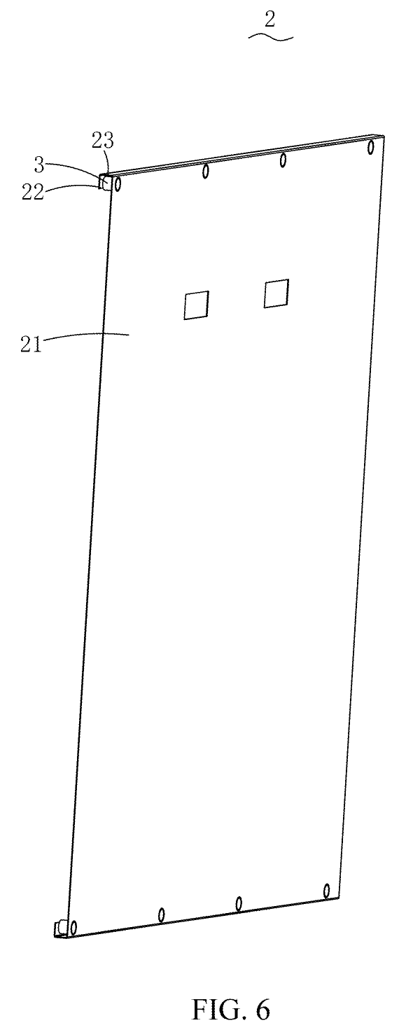

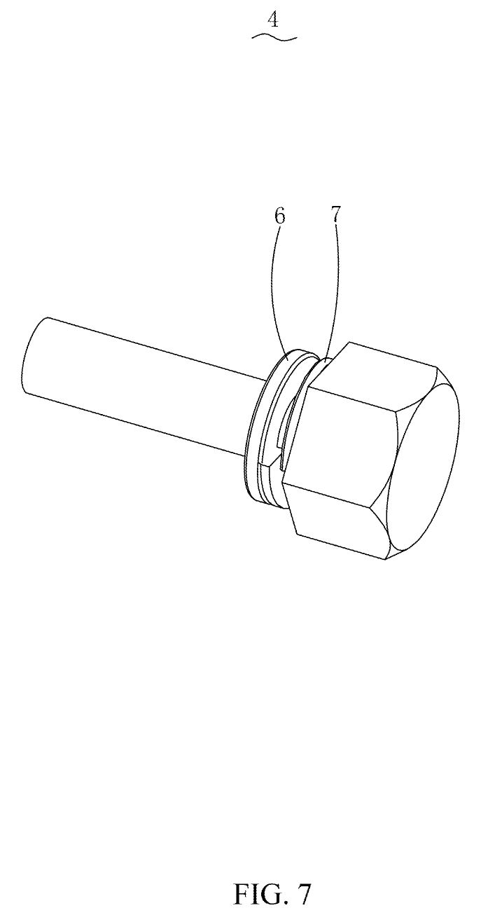

Referring to FIGS. 1-7, a cabinet panel mounting structure 100 is provided according to an embodiment of the present disclosure, which includes a cabinet frame 1, a panel 2, a plurality of sleeves 3, a plurality of bolts 4, and a plurality of blocking covers 5.

The cabinet frame 1 includes a frame body 11, two mounting grooves 12 recessed inward from a side of a periphery of the frame body 11, and a plurality of threaded portions 13 preset on the periphery of the frame body 11.

The panel 2 covers the frame body 11, and a periphery of the panel 2 is arranged in the two mounting grooves 12. The panel 2 includes a first mounting plate 21, two connecting plates 23 formed by bending and extending from two opposite ends of the first mounting plate 21 toward the frame body 11, and two second mounting plates 22 respectively formed by bending and extending from the two connecting plates 23 in opposite direction and spaced apart from each other. A plurality of avoidance holes 211 extend through the first mounting plate 21, and a plurality of through holes 221 extend through the second mounting plates 22. Each of the avoidance holes 211 corresponds to any one of the through holes 221, and the second mounting plates 22 are attached to the frame body 11, so that the through holes 221 are arranged corresponding to the threaded portions 13. Optionally, four panels 2 are provided, and every two panels are arranged side by side along a height direction of the cabinet frame 1.

In some embodiments, the avoidance hole 211 is a structural hole, such as an open circular hole, a waist-shaped hole, a rectangular hole, a polygonal hole, etc. The through hole 221 is a structural hole, such as an open circular hole, a waist-shaped hole, a rectangular hole, a polygonal hole, etc.

One end of each sleeve 3 is arranged in a respective avoidance hole 211, the other end of the sleeve 3 abuts against the second mounting plate 22 and is arranged opposite to a respective through hole 221, and the sleeve 3 is configured to prevent the bolt 4 from falling off.

Each bolt 4 sequentially passes through a respective avoidance hole 211, a respective sleeve 3, and a respective through hole 221, and extends to be screwed and fixed to a respective threaded portion 13. Each blocking cover 5 is arranged in a corresponding avoidance hole 211 and abuts against an end of the bolt 4 away from the cabinet frame 1.

Specifically, the panel 2 is correspondingly mounted in the mounting groove 12, so that the first mounting plate 21 and the external frame body 11 are positioned on a same surface, thereby realizing the corresponding installation of the panel 2. The bolt 4 passes through the first mounting plate 21 of the panel 2 through the avoidance hole 211, and then passes through the through hole 221 of the second mounting plate 22 to connect with the threaded portion 13 of the cabinet frame 1 according to a predetermined pre-tightening force. Finally, the blocking cover 5 is used to cooperate with the avoidance hole 211 of the first mounting plate 21 to block the avoidance hole 211. In this way, the characteristics of effective anti-loosening and convenient installation can be maintained. In addition, by using the two-layer structure formed by the first mounting plate 21 and the second mounting plate 22 of the panel 2, and the cooperation of the blocking cover 5 and the avoidance hole 211, the bolt head is hidden between the first mounting plate 21 and the second mounting plate 22, and the indentation possibly caused by the fastening of the bolt 4 is shielded, so that the cabinet is more beautiful and aesthetic.

In some embodiments, the plurality of avoidance holes 211 are arranged side by side, and the plurality of through holes 221 are arranged side by side.

In some embodiments, the blocking cover 5 includes a blocking cover body 51 and a connecting portion 52 formed by extending the blocking cover body 51 toward the cabinet frame 1. The connecting portion 52 is inserted into the sleeve 3 and abuts against the end of the bolt 4 away from the cabinet frame 1, and the blocking cover body 51 abuts against a side of the first mounting plate 21 away from the cabinet frame, so that the blocking cover body 51 can block the avoidance hole 211. The connecting portion 52 abuts against the bolt 4, so that the bolt 4 is hidden between the first mounting plate 21 and the second mounting plate 22, thereby realizing the hidden installation of the bolt 4.

In some embodiments, the cabinet panel mounting structure further includes flat washers 6 and elastic washers 7. An elastic washer 7 and a flat washer 6 are sleeved on a screw rod of the respective bolt 4 and clamped between a bolt head of the bolt 4 and the second mounting plate 22. The flat pad 6 and the elastic pad 7 are sleeved on and matched with the bolt 4, then the matched bolt 4 passes through the first mounting plate 21 of the panel 2 through the avoidance hole 211, and the bolt 4 passes through the through hole 221 of the second mounting plate 22 to connect with the threaded portion 13 of the cabinet frame 1 according to a predetermined pre-tightening force. Finally, the blocking cover 5 is used to cooperate with the avoidance hole 211 of the first mounting plate 21 to block the avoidance hole 211. In this way, the effect of effective anti-loosening and convenient installation can be maintained.

In some embodiments, a size of the avoidance hole 211 is greater than or equal to a diameter of the flat washer 6, which facilitates the assembly of the flat washer 6 and the elastic washer 7.

In some embodiments, a distance between the first mounting plate 21 and the second mounting plate 22 is greater than or equal to a sum of a thicknesses of the bolt head of the bolt 4, a thickness of the flat washer 6 matched with the bolt 4 and a thickness of the elastic washer 7 matched with the bolt 4, which facilitates hiding the bolt head of the bolt 4, the flat washer 6 and the elastic washer 7 between the first mounting plate 21 and the second mounting plate 22, thereby realizing the hidden installation of the bolt 4. Alternatively, both the flat washer 6 and the elastic washer 7 have circular structures. The elastic washer 7 has a spring leaf structure.

In some embodiments, a size of the through hole 221 is greater than or equal to a nominal diameter of a screw rod of the bolt 4, which facilitates the installation and fixation of the bolt 4.

In some embodiments, the first mounting plate 21 is parallel to the second mounting plates 22, which facilitates the convenient installation of the panel 2.

In some embodiments, the connecting plate 23 is perpendicular to the first mounting plate 21 and the second mounting plates 22.

In some embodiments, the threaded portion 13 is any one of a threaded hole, a welded nut, a pressing rivet nut and a pulling rivet nut, which facilitates screwing and fixing with the bolt 4.

Compare with that related art, in the cabinet panel mounting structure according to the present disclosure, the plurality of threaded portions preset on the frame body are arranged on the cabinet frame. The plurality of avoidance holes extend through the first mounting plate of the panel, and the plurality of through holes extend through the second mounting plates. Each avoidance hole corresponds to the respective through hole, and the second mounting plates are attached to the frame body, so that the through holes are arranged corresponding to the threaded portions. One end of each sleeve is arranged in the respective avoidance hole, and the other end abuts against the second mounting plate and is opposite to the respective through hole. Each bolt sequentially passes through the respective avoidance hole, the respective sleeve and the respective through hole, and extends to be screwed and fixed to the respective threaded portion. Each blocking cover is arranged in the respective avoidance hole and abuts against the end of the bolt away from the cabinet frame. By using the two-layer structure formed by the first mounting plate and the second mounting plate of the panel and the cooperation of the blocking cover and the avoidance hole, the bolt head is hidden between the first mounting plate and the second mounting plate, and the indentation possibly caused by the fastening of the bolt is shielded, so that the cabinet body is more beautiful and aesthetic.

The above are only the embodiments of the present disclosure. It should be pointed out that for those skilled in the art, various improvements can be made without departing from the creative concept of the present disclosure, but all such improvements fall within the protection scope of the present disclosure.

What is claimed is:

1. A cabinet panel mounting structure, comprising:
a cabinet frame, including a frame body, a mounting groove recessed inward from a side of a periphery of the frame body, and a plurality of threaded portions preset on the periphery of the frame body;
a panel, covering the frame body and having a periphery arranged in the mounting groove, wherein the panel includes a first mounting plate, two connecting plates formed by bending and extending from two opposites ends toward the frame body, and two second mounting plates respectively formed by bending and extending from the two connecting plates in opposite directions and spaced apart from each other, a plurality of avoidance holes extend through the first mounting plate, a plurality of through holes extend through the two second mounting plates, a respective avoidance hole of the plurality of avoidance holes corresponds to a respective through hole of plurality of through holes, and the two second mounting plates are attached to the frame body to align the plurality of through holes with the plurality of threaded portions;
a plurality of sleeves, wherein one end of a respective sleeve of the plurality of sleeves is arranged in a respective avoidance hole of the plurality of avoidance holes, and the other end of the respective sleeve abuts against a respective second mounting plate and is arranged opposite to a respective through hole of the plurality of through holes;
a plurality of bolts, wherein a respective bolt of the plurality of bolts passes through a respective avoidance hole, a respective sleeve and a respective through hole in a listed sequence, and extends to be screwed and fixed to a respective threaded portion; and
a plurality of blocking covers, wherein a respective blocking cover of the plurality of blocking covers is arranged in a respective avoidance hole and abuts against an end of a respective bolt away from the cabinet frame.

2. The cabinet panel mounting structure according to claim 1, wherein the plurality of avoidance holes are arranged side by side, and the plurality of through holes are arranged side by side.

3. The cabinet panel mounting structure according to claim 1, wherein the respective blocking cover includes a blocking cover body and a connecting portion formed by extending the blocking cover body toward the cabinet frame, the connecting portion is inserted into a respective sleeve and abuts against the end of the respective bolt away from the cabinet frame, and the blocking cover body abuts against a side of the first mounting plate away from the cabinet frame.

4. The cabinet panel mounting structure according to claim 1, further comprising flat washers and elastic washers, wherein a respective elastic washer of the elastic washers and a respective flat washer of the flat washers are sleeved on a screw rod of the respective bolt and clamped between a bolt head of the respective bolt and the respective second mounting plate.

5. The cabinet panel mounting structure according to claim 4, wherein a size of the respective avoidance hole is greater than or equal to a diameter of the respective flat washer.

6. The cabinet panel mounting structure according to claim 4, wherein a distance between the first mounting plate and the respective second mounting plate is greater than or equal to a sum of a thickness of the bolt head of the respective bolt, a thickness of the respective flat washer matched with the respective bolt and a thickness of respective the elastic washer matched with the respective bolt.

7. The cabinet panel mounting structure according to claim 1, wherein a size of the respective through hole is greater than or equal to a nominal diameter of a screw rod of the respective bolt.

8. The cabinet panel mounting structure according to claim 1, wherein the first mounting plate is parallel to the two second mounting plates.

9. The cabinet panel mounting structure according to claim 1, wherein the two connecting plates are perpendicular to the first mounting plate and the two second mounting plates.

10. The cabinet panel mounting structure according to claim 1, wherein a respective threaded portion of the plurality of threaded portions is any one of a threaded hole, a welded nut, a pressing rivet nut and a pulling rivet nut.
